(19) United States
(12) Patent Application Publication
(10) Pub. No.: US 2006/0192736 A1
(43) Pub. Date: Aug. 31, 2006

(54) Information processing apparatus and its control method

(75) Inventor: Ryoji Ninomiya, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/363,086

(22) Filed: Feb. 28, 2006

(30) Foreign Application Priority Data
Feb. 28, 2005 (JP) 2005-054273

(51) Int. Cl. G09G 3/36

(52) U.S. Cl. 345/87

(57) ABSTRACT

According to one embodiment, an information-processing apparatus includes a display panel, a filter arranged to face one surface of the display panel, and driven based on a filter driving signal to control, in accordance with a value of the filter driving signal, an amount of a light headed in a predetermined direction other than a roughly normal direction of a surface of the display panel, an input section, and a control section which adjusts the value of the filter driving signal in accordance with an operation of the input section.

### CROSS-REFERENCE TO RELATED APPLICATIONS

This application is based upon and claims the benefit of priority from Japanese Patent Application No. 2005-054273, filed Feb. 28, 2005, the entire contents of which are incorporated herein by reference.

### BACKGROUND

1. Field

The present invention relates to an information-processing apparatus, for example, having a privacy filter to make peeping difficult.

2. Description of the Related Art

Recently, a liquid crystal display device has been in wide use as a display device for a notebook computer, a monitor, or the like. Angle dependence of the visual field of the liquid crystal display device has been improved to provide a visual field angle equal to that of a CRT.

However, for example, mainly for use of a portable terminal or the like, there is a demand for a display which enables seeing from the front and makes seeing from an oblique direction difficult. This is for the purpose of preventing over seeing of information by those other than a user present roughly in front of the display when a secret document or the like is prepared or read in public. The display enables reading or writing of private mail without being bothered by surroundings.

As a technology of controlling the angle of a visual field, a technology that uses a liquid crystal panel (which will hereinafter be referred to as “a visual field angle control filter”) has been disclosed (Jpn. Pat. Appln. KOKAI Publication No. 2004-133334). According to the technology described in the literature, when the visual field angle control filter is turned on, a blocking pattern is seen from an oblique direction to protect information of a screen such as a document. When the visual field angle control filter is turned off, an image can be seen on an image display panel for image displaying by the original angle of the visual field.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of a schematic configuration of a personal computer according to a first embodiment of the present invention;

FIG. 2 is an exemplary diagram showing an example of an arrangement relation between an LCD and a privacy filter according to the first embodiment;

FIG. 3 is an exemplary sectional view showing an example of a configuration of the privacy filter according to the first embodiment;

FIG. 4 is an exemplary plan view showing an example of a configuration of the privacy filter according to the first embodiment;

FIG. 5 is an exemplary plan view showing an example of an orientation direction of an oriented film of the privacy filter according to the first embodiment;

FIGS. 6A and 6B are exemplary explanatory diagrams each showing an example of rising of a liquid crystal molecule by voltage application;

FIG. 7 is an exemplary explanatory diagram showing an example of visual field angle control by the privacy filter;

FIG. 8 is an exemplary block diagram showing an example of circuitry of the personal computer according to the first embodiment;

FIG. 9 is a block diagram showing an example of a configuration to drive the privacy filter;

FIG. 10 is an exemplary flowchart showing an example of processing to switch driving of the privacy filter;

FIG. 11 is an exemplary flowchart showing an example of processing to adjust contrast of a blocking pattern;

FIG. 12 is an exemplary block diagram showing an example of a configuration of a personal computer according to a second embodiment; and

FIG. 13 is an exemplary block diagram showing an example of a configuration to simultaneously stop driving voltage supplying to an LCD and driving voltage supplying to a privacy filter.

### DETAILED DESCRIPTION

Various embodiments according to the invention will be described hereinafter with reference to the accompanying drawings. In general, according to one embodiment of the invention, an information-processing apparatus comprises: a display panel; a filter arranged to face one surface of the display panel, and driven based on a filter driving signal to control, in accordance with a value of the filter driving signal, the amount of a light headed in a predetermined direction other than a roughly normal direction of the surface of the display panel; an input section; and a control section which adjusts the value of the filter driving signal in accordance with the operation of the input section.

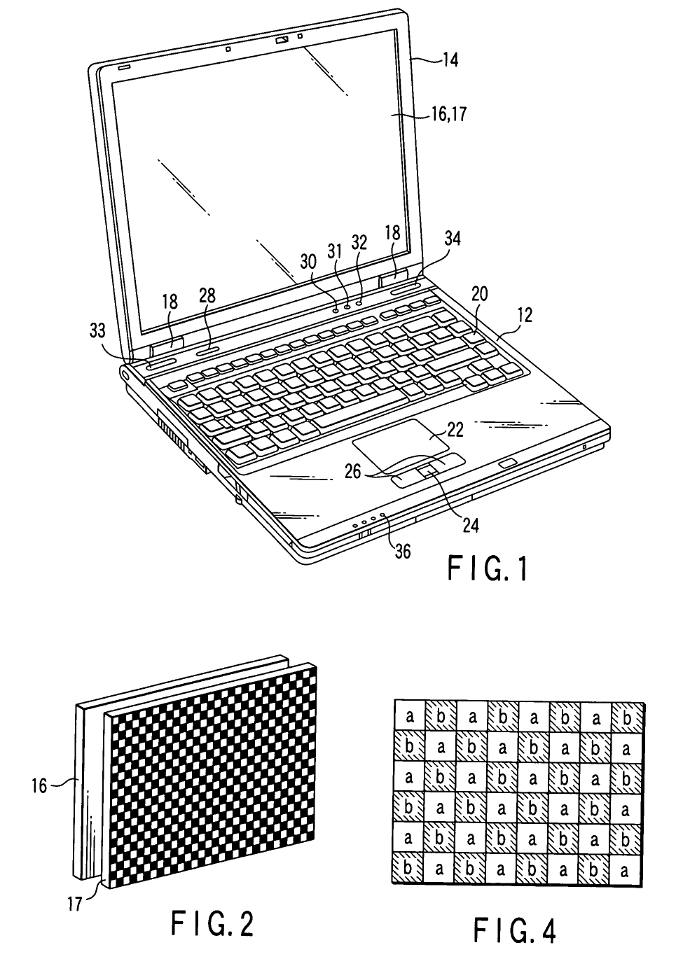

FIG. 1 is a view showing an example of a configuration of a notebook personal computer as an information-processing apparatus according to a first embodiment of the present invention.

The personal computer includes a computer main body 12 and a display unit 14. The display unit 14 incorporates a liquid crystal display (LCD) 167 and a privacy filter 17.

As shown in FIG. 2, the privacy filter 17 is mounted on an image display surface of the LCD 16. The privacy filter 17 may be mounted on a side opposed to the image display surface of the LCD 16. It can be mounted on a display having a polarizing plate such as an organic electroluminescence panel other than a liquid crystal panel on a panel surface to be used.

The display unit 14 is mounted to a hinge (support section) 18 disposed in an end of a deep side of the computer main body 12 to be rotated between an opened position in which an upper surface of the computer main body 12 is covered and a closed position in which the upper surface of the same is exposed.

The computer main body 12 has a thin box-shaped case, and a keyboard 20 is disposed in an upper surface center of the case. A palm rest is formed in a case portion upper surface in a front side of the computer main body 12. A touch pad 22, a scroll button 24, and a touch pad control button 26 are disposed almost in a center of the palm rest. In a case portion upper surface of a deep side of the computer main body 12, a power button 28 to turn on/off power for the computer main body 12, a filter on/off button 30, a contrast up button 31, a contrast down button 32, and left and right speakers 33, 34 are arranged. Various indicators (LED) 36 indicating a power supply state, an operation state of an HDD, and the like are disposed in a front of the case.

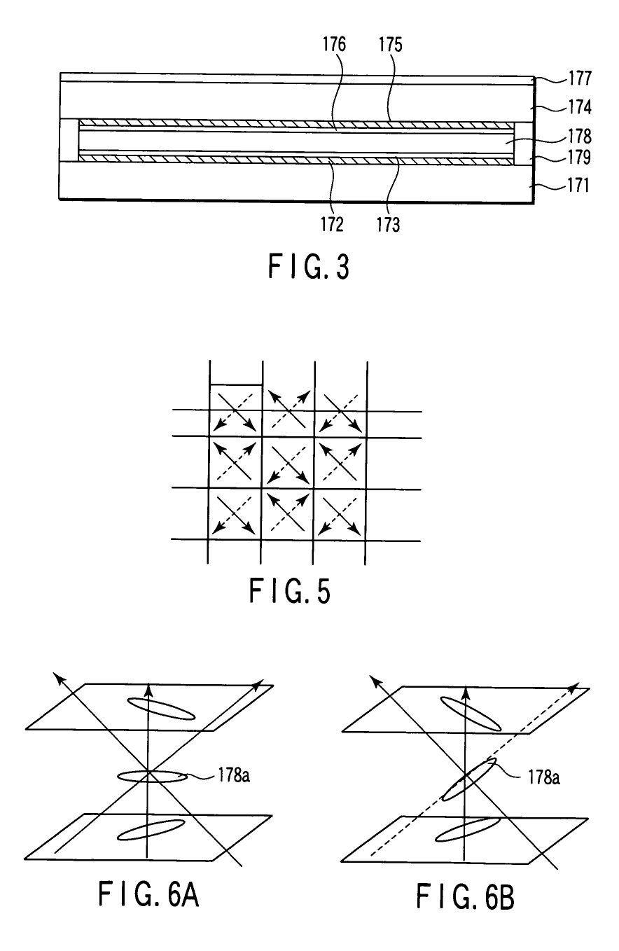

FIG. 3 is a sectional view showing an example of a privacy filter 17. A transparent electrode 172 and an oriented film 173 are sequentially staked on a transparent substrate 171 made of glass. A transparent substrate 174 is arranged to face the oriented film 173. A transparent electrode 175 and an oriented film 176 are sequentially stacked on a surface of the transparent substrate 174 which faces the oriented film 173. A polarizing plate 177 is disposed on a surface opposed to the surface of the transparent substrate 174 on which the transparent electrode 175 is formed. A liquid crystal 178 is sealed between the oriented films 173 and 176. Ends of the substrates 171 and 174 are sealed with, e.g., epoxy sealants 179.

FIG. 4 is a plan view showing an example of a privacy filter 17 according to the embodiment. As shown, two areas a, b are formed in a peeping preventing device. These areas have visible sizes. As long as they are visible, any forms such as characters or visual graphics can be used for these areas.

The areas a, b are formed by diving orientation directions of the oriented films 173 and 176 into different areas. FIG. 5 shows orientation directions of the oriented films 173 and 176.

FIG. 5 is a plan view showing an example of an orientation direction of an oriented film of a privacy filter. In FIG. 5, a solid line arrow indicates an orientation direction of the oriented film 173, and orientation directions are reverse in adjacent areas a, b. In the areas a, b, the orientation directions of the oriented films 173 and 176 are vertical to each other.

Next, an operation of the privacy filter 17 will be described.

When a voltage is not applied between the transparent electrodes 172 and 175 of the privacy filter 17, as shown in FIG. 6A, a liquid crystal molecule 178a is oriented in parallel with the substrates 171, 184. In this case, polarized light made incident on the privacy filter 17 is twisted by 90° to pass through the polarizing plate 177 irrespective of an incident direction.

When a voltage (60 Hz, sine wave) is applied to the privacy filter 17, as shown in FIG. 6B, the liquid crystal molecule 178a rises in accordance with an orientation direction of the oriented film, and is arranged in a certain helical shape. As a result, polarized light made incident from a specific direction (broken line arrow) passes through the liquid crystal without being twisted. Thus, it cannot pass through the polarizing plate 177, and a screen seen from this direction is dark. In other words, the privacy filter 17 controls an amount of a light directed in a predetermined direction other than a roughly normal direction of a surface of the LCD 16 in accordance with the voltage (filter driving voltage).

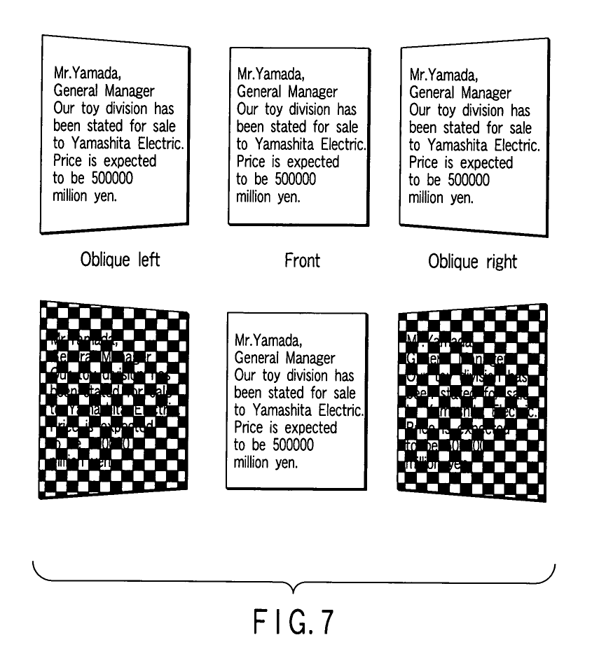

FIG. 7 shows an example of a screen seen when the privacy filter 17 is mounted on the LCD 16. In the drawing, three screens of an upper stage indicate a state in which no voltage is applied to the privacy filter 17, and three screens of a lower state indicate a state in which a voltage is applied to the privacy filter 17. Left indicates screen seen from an oblique left direction, center indicates a screen seen from the center, and right indicates a screen seen from an oblique right direction.

As described above, in the state of no voltage application, displaying is no different from normal displaying no matter which direction of the front, the oblique left and the oblique right the screen is seen from.

On the other hand, in the state of voltage application, displaying is no different from normal displaying when the screen is seen from the front. However, when the screen is seen from the oblique left and right directions, a black spot is generated to block displaying on the liquid crystal display device in accordance with an area disposed on the oriented film. By displaying such blocking graphics, recognition of the screen from an oblique horizontal direction is made difficult to prevent peeping.

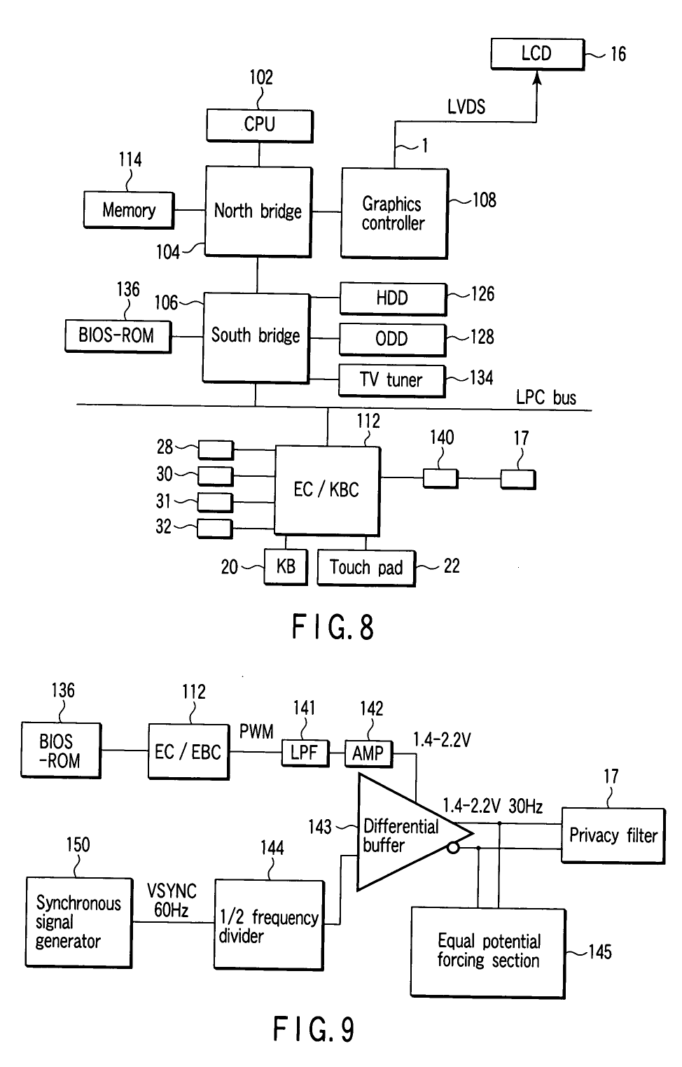

Next, referring to FIG. 8, an example of a system configuration of this computer will be described.

As shown in FIG. 8, the computer includes a CPU 102, a north bridge 104, a main memory 114, a graphics controller 108, a south bridge 106, a BIOS-ROM 136, a hard disk drive (HDD) 126, an optical disk drive (ODD) 128, a TV tuner 134, and an embedded controller/keyboard controller IC (EC/KBC) 112.

The CPU 102 is a processor disposed to control an operation of the computer, and executes an operating system OS) and various application programs loaded from the hard disk drive (HDD) 126 to the main memory 114.

The CPU 102 loads a system basic input output system (BIOS) stored in the BIOS-ROM 136 to the main memory 114, and then executes it. The system BIOS is a program for controlling hardware.

The north bridge 104 is a bridge device for connecting a local bus of the CPU 102 to the south bridge 106. The north bridge 104 includes a memory controller for controlling access to the main memory 114. The north bridge 114 has a function of executing communication with the graphics controller 108 through an accelerated graphics port (AGP) bus or the like.

The graphics controller 108 is a display controller which controls the LCD 16 used as a display monitor of the computer. This graphics controller 108 has a video memory (VRAM), and generates a video signal for forming a display image to be displayed on the LCD 16 from display data drawn in a video memory by an OS/application program. The video signal generated by the graphics controller 108 is output to a line 1.

The embedded controller/keyboard controller IC (filter control section) 112 switches driving/nondriving of the privacy filter when the filter on/off button 30 is operated and an event signal output therefrom is input. In a state in which the privacy filter 117 is not driven before the filter on/off button 30 is operated, the embedded controller/keyboard controller IC 112 outputs a signal for driving the privacy filter 17 to a filter driving section 140. A contrast set value necessary for forming a blocking pattern displayed in the privacy filter 17 is contained in, e.g., the system BIOS stored in the BIOS-ROM 136. The embedded controller/keyboard controller IC 112 refers to the contrast set value stored in the BIOS-ROM 136. The signal output from the embedded controller/keyboard controller IC 112 contains information corresponding to the contrast set value referred to.

In a state in which the privacy filter 17 is driven before the filter on/off button 30 is operated, the embedded controller/keyboard controller IC 113 outputs a signal for stopping the driving of the privacy filter 17 to the filter driving section 140.

Next, referring to FIG. 9, an operation during the driving of the privacy filter 17 will be described more in detail.

The embedded controller/keyboard controller IC 112 refers to the contrast set value contained in the system BIOS developed in the main memory 114. The embedded controller/keyboard controller IC 112 generates a pulse width modulation (PWM) signal corresponding to the contrast set value, and outputs it to the filter driving section 140. A contrast of a blocking pattern displayed in the privacy filter 17 changes in accordance with a driving voltage. In the PWM signal, a level of a driving voltage is indicated by a size of a pulse width. As the level of the driving voltage is indicated by the size of the pulse width, when no PWM signal is output, i.e., when a signal is “0”, the privacy filter 17 is not driven.

The PWM signal is input to a low pass filter 141, and the low pass filter 141 converts the PWM signal into a DC signal. A voltage value of the DC signal corresponds to a contrast. The converted DC signal is input through the low pass filter 141 to an amplifier 142, and boosted to a voltage necessary for driving the privacy filter 17. The boosted signal is input to a differential buffer 143. The differential buffer 143 applies a potential difference to two signal lines L₁, L₂ connected to the transparent electrodes 172 and 175 in accordance with a voltage input from the amplifier. A timing signal of 30 Hz is input to the operation buffer 143, and polarities of voltages supplied to the two signal lines L₁, L₂ are reversed. The reversal of polarities enables prevention of so-called burn-in. The timing signal is generated by dividing a synchronous signal VSYNC of 60 Hz generated by a synchronous signal generator 150 to a half cycle by a ½ frequency divider.

An equal potential forcing section (potential control section) 145 is connected to the two signal lines L₁, L₂. There is a dander that burn-in may occur if there is a potential difference between the two signal lines L₁, L₂ during a nonoperation of the privacy filter 17. During the nonoperation of the privacy filter 17, the equal potential signal forcing section 145 sets a potential difference between the two signal lines L₁, L₂ to a value (e. g., 0) equal to or less than a predetermined value, whereby burn-in of a liquid crystal can be suppressed. For example, the equal potential forcing section 145 is constituted of a switch to electrically interconnecting the two signal lines L₁, L₂ during the nonoperation of the privacy filter 17.

The BIOS-ROM 136 as the filter control section, the embedded controller/keyboard controller IC 112, and the filter control section 140 are disposed in the computer main body 12. As the privacy filter 17 and the filter driving section 140 are connected to each other through the two signal lines L1, L2, only two wiring lines are necessary for interconnecting the computer main body 12 and the display unit 14 to drive the privacy filter 17.

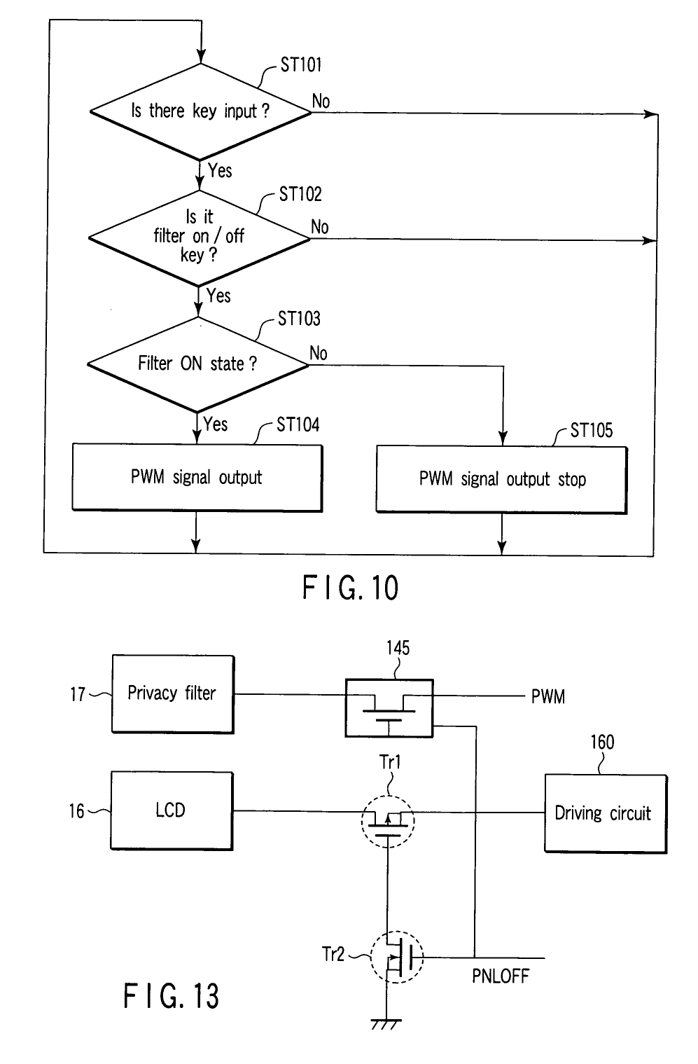

Next, referring to FIG. 10, processing for switching driving/nondriving of the privacy filter 17 will be described.

First, determination is made as to whether a key has been operated or not (block ST101). If it is determined in block ST101 that there has been no key input, block ST101 is executed at predetermined timing. If it is determined in block ST101 that a key has been operated, determination is made as to whether the operated key is a filter on/off button 30 or not (block ST102). If it is determined in block ST102 that it is not a filter on/off button 30, processing corresponding to the operated key is executed, and block ST101 is executed at predetermined timing.

If it is determined in the block ST102 that the operated key is a filter on/off button 30, determination is made as to whether the privacy filter 17 is in a driven state or not (block ST103). If a driven state of the privacy filter 17 is determined in block ST103, outputting of a PWM signal is stopped to halt the driving of the privacy filter 17, and the driving of the privacy filter 17 is stopped (block ST104). If a driven state of the privacy filter 17 is not determined in block ST103, a PWM signal is output to drive the privacy filter 17 (block ST105).

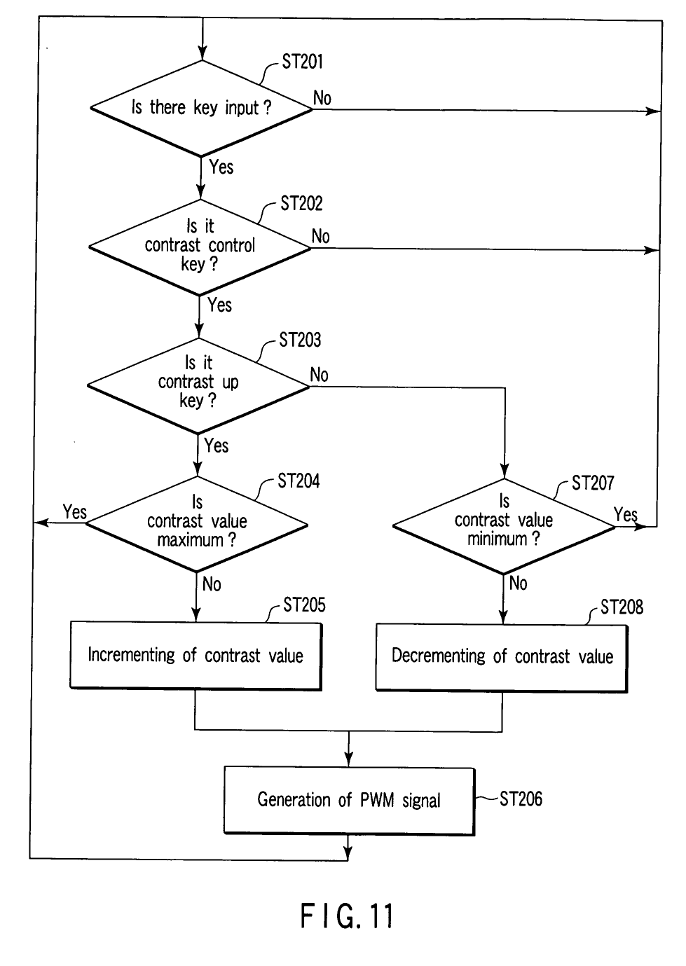

Next, referring to FIG. 11, processing for adjusting a contrast of a blocking pattern during driving of the privacy filter 17 will be described.

The embedded controller/keyboard controller IC 112 determines whether a key has been operated or not (block ST201). If it is determined that there has been no key operation, block ST201 is executed at predetermined timing. Determination is made as to whether operated keys are contrast control buttons 31, 32 or not. If the operated keys are not contrast buttons 31, 32, the embedded controller/keyboard controller IC 112 executes processing corresponding to the operated keys, and block ST201 is executed at predetermined timing.

If it is determined in block ST202 that the operated keys are contrast control buttons 31, 32, the embedded controller/keyboard controller IC 112 determines whether the key is a contrast up button 31 or not (block ST203). If it is determined in block ST203 that it is a contrast up button 31, the embedded controller/keyboard controller IC 112 refers to a contrast set value contained in the system BIOS developed in the main memory 114 to determine whether the recorded contrast set value is maximum within a set range or not (block ST204). If it is determined that the contrast set value is maximum, the contrast cannot be changed, and thus the process returns to block ST201.

If it is determined in block ST204 that the contrast set value is not maximum, the set contrast set value is incremented to a contrast set value larger by one stage. Then, a PWM signal is generated based on the changed contrast set value (block ST206).

If it is determined in block ST203 that the key is not a contrast up button 31, the embedded controller/keyboard controller IC 112 determines whether the set contrast set value is minimum within the set range or not (block ST207). A case in which the key is determined not to be a contrast up key 31 means that the contrast down button 32 has been pressed. When it is determined in block ST207 that the contrast set value is minimum, the contrast cannot be changed, and thus the process returns to block ST201.

If the contrast set value is not minimum, the contrast set value contained in the system BIOS developed in the main memory 114 is decremented to a contrast set value smaller by one stage (block ST208). Then, a PWM signal having a new pulse width is generated based on the changed contrast set value (block ST206).

As described above, by operating the contrast up button 31 or the contrast down button 32, it is possible to adjust the contrast of the blocking pattern displayed in the privacy filter 17. For example, even when a temperature is low, and the contrast of the blocking pattern displayed in the privacy filter 17 is low to permit seeing from an oblique direction of the display, the user operates the contrast up button 31 to increase the contrast of the blocking pattern, whereby peeping from the oblique direction can be prevented.

The embodiment has been described by taking the example of operating the contrast up button 31 or the contrast down button 32 to adjust the contrast. However, the contrast may be adjusted by operating a plurality of keys disposed in a keyboard 20 (e.g., plurality of keys for operating a hot key function to which a contrast adjusting function is assigned) or utilities operated on the OS. That is, as seeing from the oblique direction is necessary for checking the contrast of the blocking pattern, a button used for adjusting the contrast is preferably arranged in a position of an easy operation executed in a state of seeing from the oblique direction.

### SECOND EMBODIMENT

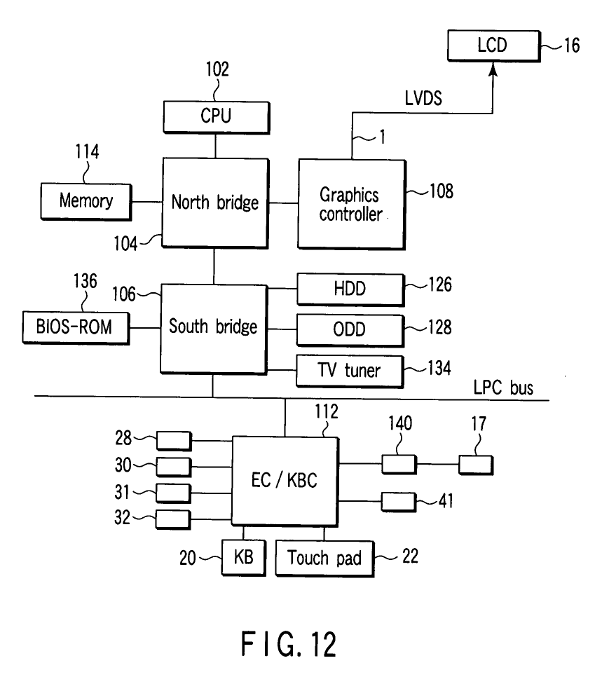

FIG. 12 is a block diagram showing an example of a configuration of a personal computer according to a second embodiment of the present invention. In FIG. 12, positions similar to those of FIG. 8 are denoted by similar reference numerals, and detailed description thereof will be omitted.

In FIG. 12, a temperature sensor 41 is connected to an embedded controller/keyboard controller IC 112. The temperature sensor 41 is arranged in a computer main body 12, e.g., in a battery, near a hard disk drive (HDD) 126, or near an optical disk drive (ODD) 128. The temperature sensor 41 may be arranged in a display unit 14.

The embedded controller/keyboard controller IC 112 stores a temperature measured by the temperature sensor in, e.g., a main memory 14. The temperature is preferably measured at the time of starting the personal computer. There are many heat sources for a CPU 102 or the like in the computer main body 12 as compared with the display unit 14. With a passage of time from the start, a temperature difference is generated between the computer main body 12 and the display unit 14 which stores a privacy filter 17, making it difficult to correct a PWM signal later.

While the privacy filter 17 is not driven, a filter on/off button 30 is operated, and the embedded controller/keyboard controller IC 112 outputs a PWM signal based on a contrast set value and temperature information prestored in a BIOS-ROM 136. At this time, the embedded controller/keyboard controller IC 112 decides a pulse width of the PWM signal in accordance with the contrast set value, and corrects the decided pulse width in accordance with the temperature information.

If the temperature sensor 14 is disposed in the display unit 14, the pulse width of the PWM signal is preferably corrected after driving of the privacy filter 17 is instructed. A temperature may be periodically measured during driving of the privacy filter 17 to obtain a new correction value, and the privacy filter 17 may be driven based on the new correction value.

By correcting the PWM signal in accordance with a temperature measured by the temperature sensor 141, a contrast be automatically set in an optimal state even without adjusting the contrast by a user.

A case in which the display unit 14 is closed or displaying is carried out on an external monitor will be described. In this case, while a signal for displaying an image is sent to an LCD 16, control is executed to stop supplying of a driving voltage to the LCD 16 thereby preventing its driving. When the privacy filter 17 is in a driven state, wasteful consumption of power continues. Accordingly, operation time becomes shorter during an operation by a battery.

Referring to FIG. 13, a configuration of the embodiment to simultaneously stop supplying of a driving voltage to the LCD 16 and supplying of a driving voltage to the privacy filter 17 will be described.

A p type transistor Tr1 is inserted between a driving circuit 160 for supplying a driving voltage to the LCD 16, and the LCD 16. A PNLOFF signal generated by executing a system BIOS developed in the main memory 14 is input to a gate of an n type transistor Tr2 and an equal potential forcing section 145. One end of the n type transistor Tr2 is connected to ground, and the other end of the n type transistor Tr2 is input to the gate of the p type transistor Tr1.

The PNLOFF signal is at “Hi” when power is supplied to the LCD 16, and set to “Low” when the supplying of the power to the LCD 16 is stopped.

When the PNLOFF signal is at “Hi”, the n type transistor Tr2 is set in an ON state, and the gate of the p type transistor Tr1 is connected to ground to be set in an ON state, thereby supplying a driving voltage from the driving circuit 160 to the LCD 16. When the PNLOFF signal is at “Hi”, the equal potential forcing section 145 is enabled to supply a driving voltage to the privacy filter 17 in accordance with the PWM signal.

When the PNLOFF signal is at “Low”, the n type transistor Tr2 is set in an OFF state, and the gate of the p type transistor Tr1 is set in an OFF state without being connected to the ground, thereby preventing supplying of a driving voltage from the driving circuit 160 to the LCD 16. When the PNLOFF signal is at “Low”, the equal potential forcing section 145 prevents supplying of a driving voltage to the privacy filter 17, and electrically interconnects two signal lines connected to the privacy filter to set equal potentials, thereby preventing burn-in.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information-processing apparatus comprising:
a display panel;
an input section; and
a filter arranged to face one surface of the display panel, and which controls an amount of a light headed in a predetermined direction other than a roughly normal direction of a surface of the display panel in accordance with an operation of the input section.

2. The information-processing apparatus according to claim 1, further comprising a temperature sensor,
wherein the filter controls the amount of the light in accordance with a temperature measured by the temperature sensor.

3. The information-processing apparatus according to claim 1, the filter including a liquid crystal layer held between a pair of electrodes, further comprising,
a potential control unit which sets a potential difference between the pair of electrodes to a predetermined value or less when the filter is not driven.

4. The information-processing apparatus according to claim 1, wherein the controlling the amount of light is stopped in accordance with a stop driving the display panel.

5. The information-processing apparatus according to claim 1, wherein:
the input section includes a contrast up-key and a contrast down-key, and
the filter controls the amount of the light in accordance with operations of the contrast up-key or the contrast down-key.

6. An information-processing apparatus comprising:
a display panel;
a filter arranged to face one surface of the display panel, and driven based on a filter driving signal to control an amount of a light headed in a predetermined direction other than a roughly normal direction of a surface of the display panel;
an input section; and
a control section which adjusts the filter driving signal in accordance with an operation of the input section.

7. The information-processing apparatus according to claim 6, further comprising a temperature sensor,
wherein the control unit includes a correction unit to correct the filter driving signal in accordance with a measured temperature of the temperature sensor.

8. The information-processing apparatus according to claim 6, the filter including a liquid crystal layer held between a pair of electrodes, further comprising,
a potential control unit which sets a potential difference between the pair of electrodes to a predetermined value or less when the filter is not driven.

9. The information-processing apparatus according to claim 6, the filter including a liquid crystal layer held between a pair of electrodes, further comprising
a potential control unit which sets a potential difference between the pair of electrodes to a predetermined value or less in accordance with a stop signal to stop supplying of a panel driving signal to the display panel.

10. The information-processing apparatus according to claim 6, wherein:
the input section includes a contrast up-key and a contrast down-key, and
the control unit adjusts the filter driving signal in accordance with operations of the contact up-key or the contrast down-key.

11. A method of controlling an information-processing apparatus comprising:
detecting an operation of an input section; and
controlling an amount of a light headed in a predetermined direction other than a roughly normal direction of a surface of a display panel by a filter arranged to face one surface of the display panel when the operation of the input section is detected.

12. The method according to claim 11, further comprising:
measuring a temperature; and
controlling the amount of the light in accordance with the measured temperature.

13. The method according to claim 11, the filter including a liquid crystal layer held between a pair of electrodes, further comprising,
setting a potential difference between the pair of electrodes to a predetermined value or less when the filter is not driven.

14. The method according to claim 11, further comprising:
stopping a control of the amount of light in accordance with a stop driving the display panel.

15. The method according to claim 11, wherein the controlling controls the amount of the light in accordance with operation of a contrast up-key or a contrast down-key.
